(19) United States
(12) Patent Application Publication
(10) Pub. No.: US 2015/0242518 A1
(43) Pub. Date: Aug. 27, 2015

(54) SYSTEMS AND METHODS FOR CLOSED LOOP CONFIRMATION OF USER GENERATED CONTENT

(71) Applicants: Debbie Rosenbaum, San Francisco, CA (US); Sharon Le Duy, Piedmont, CA (US); Scott Bedard, San Carlos, CA (US)

(72) Inventors: Debbie Rosenbaum, San Francisco, CA (US); Sharon Le Duy, Piedmont, CA (US); Scott Bedard, San Carlos, CA (US)

(21) Appl. No.: 14/635,486

(22) Filed: Mar. 2, 2015

Related U.S. Application Data
(63) Continuation-in-part of application No. 13/772,305, filed on Feb. 20, 2013.
Application No. 13/772,305 is a continuation-in-part of application No. 13/644,389, filed on Oct. 4, 2012.
(60) Provisional application No. 61/947,418, filed on Mar. 3, 2014.

(51) Int. Cl. G06F 17/30

(52) U.S. Cl. CPC G06F 17/30867; G06F 17/30598

(57) ABSTRACT

The present invention relates to systems and methods for closed loop confirmation of user generated content. A content management system filters user generated content from at least one content platform to identify content of interest. After content of interest is collected, the user may be asked for permission to use this content. Approval may be sought within the content platform, or may include a redirect to an external website. After approval has been collected, the content is marked as monetizable and provided to brand owners and advertisers for their usage. Additionally, statistics may be generated for the user indicating their approval ratios and their propensity to generate content of interest. These statistics may assist in determining which content should be filtered for in the future.

### CROSS REFERENCE TO RELATED APPLICATIONS

This non-provisional application claims the benefit of and is a continuation-in-part of U.S. provisional patent application No. 61/947,418, filed on Mar. 3, 2014, of the same title.

Also, this application is a continuation-in-part of U.S. patent application Ser. No. 13/772,305, filed on Feb. 20, 2013, entitled “Systems and Methods for Automated Channel Addition,” which in turn is a continuation-in-part of U.S. patent application Ser. No. 13/644,389, filed on Oct. 4, 2012, entitled “Systems and Methods for Automated Reprogramming of Displayed Content.”

All applications listed above are hereby fully incorporated in their entirety by this reference.

### BACKGROUND

The present invention relates to systems and methods for closed loop confirmation of approval to use user generated content. Such systems and methods are particularly useful in the context of online activities, and may be especially useful in social media and advertising. Such systems and methods enable advertisers to leverage the vast content pool generated by users for goods and services, without concern of legal risk for copyright violation, misappropriation of likeness, or other privacy violations.

With the increase in user generated content being uploaded onto social networking sites, there is a vast untapped resource of material that could benefit advertisers. Often user generated content is able to trend with popular opinion and trends much faster than a company is able to react to. Thus not only is user generated content plentiful and free, but it is often more relevant to the target audience than advertising generated by a paid firm. Likewise, user generated content is perceived as more “authentic” by many target audiences, which can be a highly coveted, yet elusive, goal of advertisers.

However, user generated content, while plentiful, is a legal minefield for many brand-owners and advertisers. Many users are pleased with the concept of their content being employed in advertisements. However, some users are opposed to the concept, or may become opposed to the content being monetized when they realize they may be able to profit from the usage of their content without authorization.

To make matters even more complicated, the ability to be anonymous and privacy afforded to users by social networking sites makes the collection of approvals for the usage of user generated content difficult for most advertisers. In addition, the sheer amount of user generated content makes the finding of “good” material difficult.

This panoply of hurdles associated with using user generated content has caused most brand owners and advertisers to limit their usage of user generated content to that which is provided under an agreement which provides them access to the content. This often takes the form of branded sites where users are invited to present their comments and images regarding the specific product. While these solutions to collecting user generated content are admirable, they still miss out on the lion's share of user content that is being generated every day.

It is therefore apparent that an urgent need exists for systems and methods for closed loop confirmation of authorization to use content that has been generated by users. Such systems and methods would be able to provide advertisers the ability to leverage mostly untapped content resources while minimizing legal risks.

### SUMMARY

To achieve the foregoing and in accordance with the present invention, systems and methods for closed loop confirmation are provided. Such systems and methods enable advertisers to access a much wider field of user generated content without concerns over the legality of utilizing the content.

In some embodiments, a content management system filters user generated content from at least one content platform to identify content of interest. This filtering may include keyword searches. Keyword contextual searches. Image and facial recognition, and audio recognition. Recognition software may be designed to identify brand identifiers (such as product images, logos, trademarks and the like). Facial recognition may also ensure that all parties' approval is sought prior to monetization of the content.

After content of interest is collected, the user may be asked for permission to use this content. Approval may be sought within the content platform, or may include a redirect to an external website. After approval has been collected, the content is marked as monetizable and provided to brand owners and advertisers for their usage. Additionally, statistics may be generated for the user indicating their approval ratios and their propensity to generate content of interest. These statistics may assist in determining which content should be filtered for in the future.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is an example functional block diagram illustrating users engaging a content management system capable of closed loop confirmation, in accordance with some embodiments;

FIG. 2 is an example block diagram for the content management system which includes a campaign manager, in accordance with some embodiments;

FIG. 3 is an example flow chart for the process of automatically adding a channel, in accordance with some embodiments;

FIG. 4 is an example flow chart for the sub-process of content selection, in accordance with some embodiments;

FIG. 5 is an example flow chart for selecting the best content for the specific user, in accordance with some embodiments;

FIG. 6 is an example flow chart for feedback analysis, in accordance with some embodiments;

FIG. 7 is an example diagram for a template form which channels complete in order to gain compatibility with the automated channel addition, in accordance with some embodiments;

FIG. 8 is an example screenshot of a social network site, in accordance with some embodiments;

FIG. 9 is an example block diagram for the campaign manager, in accordance with some embodiments;

FIG. 10 is an example flow chart for closed loop confirmation of approval to use the user generated content, in accordance with some embodiments;

FIG. 11 is an example flow chart for the filtering of user content, in accordance with some embodiments;

FIG. 12 is an example flow chart for seeking user approval, in accordance with some embodiments;

FIG. 13 is an example screenshot for a campaign manager, in accordance with some embodiments;

FIG. 14 is an example screenshot for a closed loop confirmation request, in accordance with some embodiments;

FIG. 15 is an example screenshot for a content gallery, in accordance with some embodiments;

FIG. 16 is an example screenshot for an approval status field, in accordance with some embodiments;

FIGS. 17 and 18 are example screenshots for a webpage hosted user approval screen, in accordance with some embodiments;

FIGS. 19-21 are example screenshots for a user approval screen on a mobile device application, in accordance with some embodiments; and

FIGS. 22A and 22B are example illustrations for computer systems configured to embody the content management system capable of automated channel addition, in accordance with some embodiments.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention. It will be apparent, however, to one skilled in the art, that embodiments may be practiced without some or all of these specific details. In other instances, well known process steps and/or structures have not been described in detail in order to not unnecessarily obscure the present invention. The features and advantages of embodiments may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

The present invention relates to a novel means, systems and methods for closed loop confirmation of the ability to utilize user generated content. These systems and methods may be particularly useful within social media settings, where user data is rich, but is currently relatively inaccessible due to legal considerations such as copyright and privacy laws.

Note that while much of the discussion contained herein relates to social networks, it is entirely possible that any content host may utilize the disclosed systems and methods. For example, media sources, such as YouTube, news outlets, such as CNN online, and online retailers, such as Amazon, may all be considered “content providers” or “distribution channels” for the purposes of this disclosure. Further, advertisers may likewise be referred to as “ad providers”.

The following description of some embodiments will be provided in relation to numerous subsections. The use of subsections, with headings, is intended to provide greater clarity and structure to the present invention. In no way are the subsections intended to limit or constrain the disclosure contained therein. Thus, disclosures in any one section are intended to apply to all other sections, as is applicable.

### I. AUTOMATED CHANNEL ADDITION SYSTEM

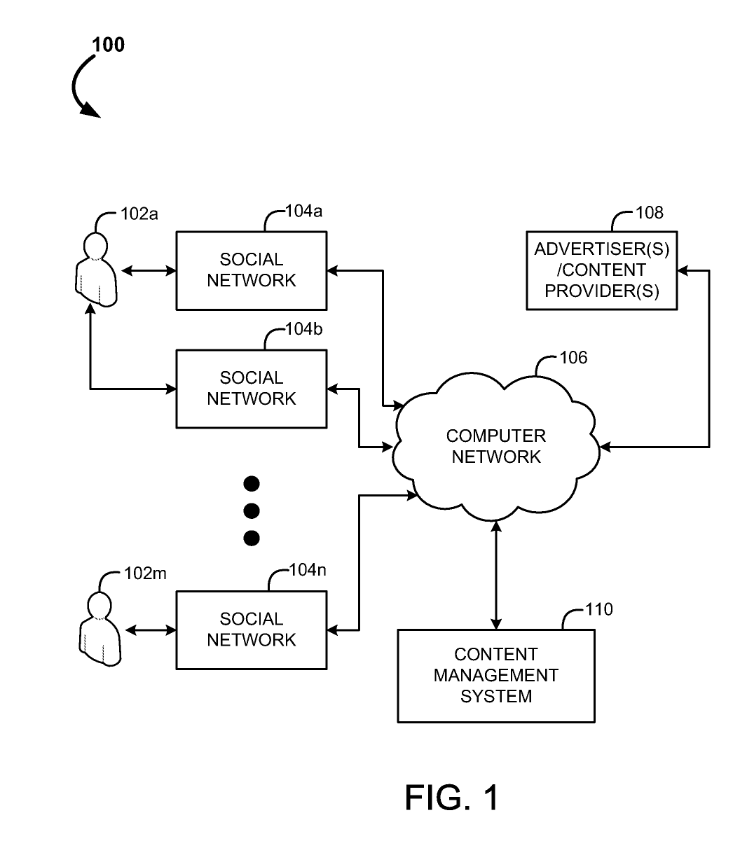

To facilitate the discussion, FIG. 1 is an example functional block diagram 100 illustrating users 102a to 102m engaging social networks 104a to 104n in conjunction with a content management system 110 to tailor the content displayed, deliver interactive advertisements, and filter user generated content, get approval to use the content and provide the content to advertisers for their usage. In this particular example illustration, two users 102a to 102m are seen interacting with one or more social networks (channels) 104a to 104n. While social networks 104a to 104n are illustrated in this example illustration, it is considered within the scope of this disclosure that a wide variety of websites may be accessed by the users 102a to 102m, including entertainment sites, news outlets, retailers, search engines, blogs, informational and reference pages, websites for organizations, social media sites, branded websites, or any other distribution channel accessible by a user.

The social networks 104a to 104n are accessed by the users 102a to 102m via a computer network 106. In some embodiments, the computer network 106 is the internet; however, it is possible that the computer network 106 may include any wide area network, local area network, company network, interactive television network, etc. The computer network 106 additionally couples the social networks 104a to 104n to a content management system 110 and advertisement network(s)/content providers 108.

The advertisement network(s) 108 may provide content (advertisements, marketing platforms, etc.) to the content management system 110. The social networks 104a to 104n provide a form providing the content management system 110 the resources necessary to tailor the content to each specific API for each social network 104a to 104n. Thus, the advertiser 108 is only required to provide one set of data to a single recipient in order to roll out advertisements to a wide number of channels.

In some embodiments, the content management system may filter social network streams and collect user content. The user content can then be filtered, and approval can be sought from the users in order to monetize the user generated content.

In some embodiments, a user 102a may access a social network 104a. The social network 104a provides the content that has been tailored by the content management system 110 to the user 102a. In some cases, the content provided to the user 102a may not only be tailored to the API of the social network, but may even be selected by the content management system 110 from a variety of possible content. In these particular embodiments, the content management system 110 operates in the background to analyze the sentiments of the user 102a to determine what content will be provided to the user. In these embodiments, the content management system 110 is capable of tying each user 102a to a persistent identification, and is linked to the user's 102a identification in each social network they frequent. This persistent identification allows the sentiment of the user 102a to be tracked across various social networks 104a to 104n (or other social networks). This enables the content management system 110 to learn about the user 102a, develop a personality profile, and make more exact predictions regarding how the user 102a will react to any particular content.

Persistent identity may also be of use when collecting user generated content. For example, if it is known that a particular user generates high quality user content, and is often willing to grant approval to use the content, then it may be beneficial to track the user across a wide range of platforms.

In addition to collecting user generated content, the content management system 110 may access statistical data generated by users on the social network. This feedback data on these channels may be tracked by the content management system 110 and utilized for further operations, such as distributed engagement channel development, improving content selection, and user analytics. This feedback data may be the number of “likes” for example, number of “shares”, and comments by users.

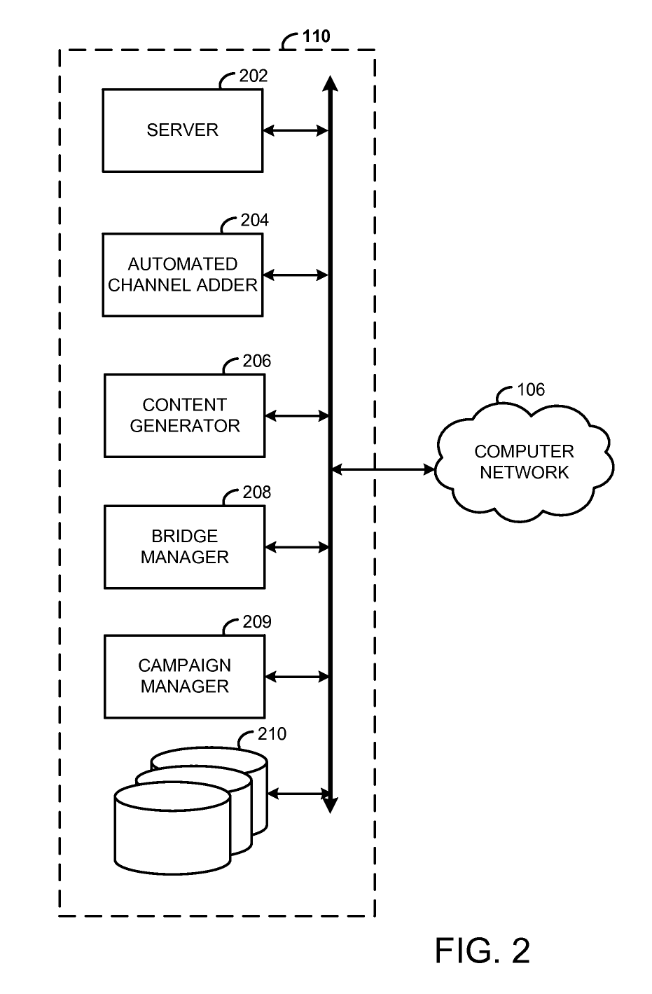

FIG. 2 is an example block diagram for the content management system 110, in accordance with some embodiments. The content management system 110 includes a server 202, an automated channel adder 204, a content generator 206, an interactive bridge manager 208, a campaign manager 209, and one or more database 210. Each of these subsystems is a logical component of the content management system 110 and is logically coupled to one another. In cases in which these subsystems are embodied upon a single device, or operating within a cloud environment, the coupling may be merely logical in nature. When these subsystems are embodied within separate devices, the coupling may include a physical connection, such as a central bus.

Each component of the content management system 110 may likewise access the computer network 106. The server 202 may interact directly with the social networks 104a to 104n (or other channels) in order to provide the content selection for a given user 102a, as well as interact with the advertisers 108. The campaign manager 209 may be the primary subsystem responsible for closed loop confirmation of a user's willingness to have their user generated content employed by advertisers.

The interactive bridge manager 208, which is optional depending upon embodiment, may generate an interactive bridge button for inclusion in the advertisements, which distributed engagement channels they link with, and which content (comments, live stats, etc.) they pull from. In some embodiments, the generated interactive bridge button may even include live statistics or other personalized content for the user. Likewise, the content generator 206 may utilize content to optimize it for each social network as will be discussed in greater detail. An interactive bridge manager 208 and content generator 206 may improve the quality of content provided to the social networks for consumption by the user. It should be noted however, that while these quality improving functions improve user engagement; they are not required to perform automated channel addition in some embodiments.

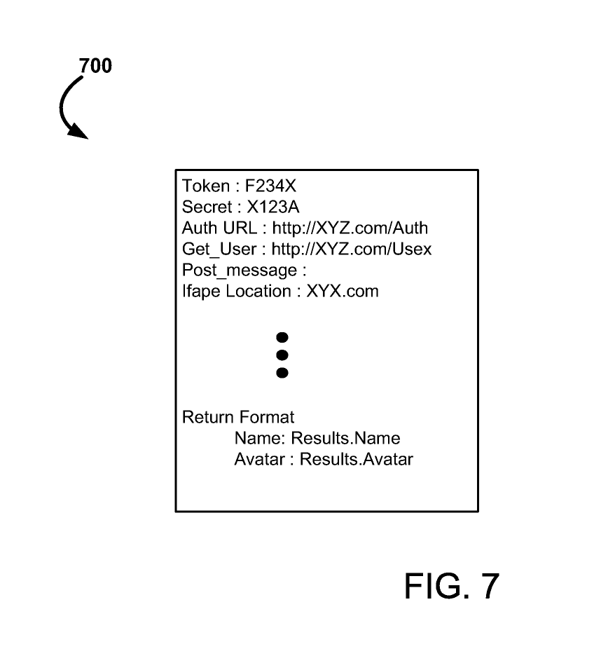

The automated channel adder 204 receives form data from the social networks 104a to 104n. An example of the form data received may be seen in relation to FIG. 7, at 700. The form data includes a token, secret, authentication url, API endpoints to get a user or other entity's info, optional extra data schema, and SLA relating to rate-limiting or other performance-affecting factors. The automated channel adder 204 can utilize the form data for configure the advertisers content to be compatible with each of the social networks APIs. Thus, the automated channel adder 204 may generate multiple versions of the advertiser's 108 content which can be added to any supported channel in an automated fashion.

Although not shown, the content generator 204 may be employed by a sentiment analyzer in order to generate probabilities that the given user 102a will react positively to a given piece of content. The profiles, available content and social network API requirements (form data) may be stored within a database 210.

The campaign manager 209 with its associated closed loop confirmation, will be described in greater detail below.

### II. CHANNEL ADDITION PROCESS

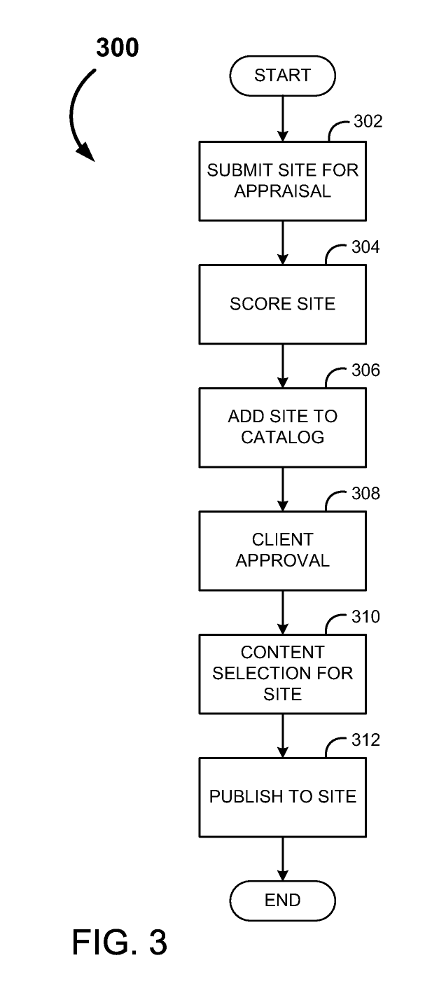

FIG. 3 is an example flow chart 300 for the process of an advertiser engaging with a content management system for automated channel addition, in accordance with some embodiments. In this process a social network (or other channel) may access the content management system. The site is submitted for appraisal by the content management system (at 302). Site submission may include providing the form data, as previously discussed in relation with FIG. 7. The form data may include an Atom XML file or equivalent. This form data is similar to existing procedures employed by Google's Hub, and as such is something social networks are already doing, thereby promoting adoption or buy-in of the presently disclosed system.

Generally the channel seeks out the content management system in order to submit their site for assessment. However, in some cases the channel may not be aware of the system. In those cases, the system could, periodically, automatically scrape the web looking for new channels. Upon finding a new one, the system could invite the new channel to submit a form per the above described step.

Next the content management system scores the site (at 304). Site scoring is not presently performed by any other system currently, as disclosed, for the automated addition of channels for advertisement distribution. Site scoring includes cataloging each participating channel (social network, etc.), and generates a score values for each site based upon the number of users, topics of conversation, sentiments on these topics, and level of user engagement. These scores may be a single composite value of the site, or may be scored in various categories. For example, a site for technophiles may have a relatively small user base, and a narrow scope of topics, but the sentiments may be high regarding this topic and its users very active. As such, an overall value score would be low, but a value score in the area of high-end technology may be high. This scoring process provides guidance to advertisers which channels they are of most value to the specific advertiser. One such scoring algorithm would be: [(proportionate change in monthly active users)/sqrt([domain variety score]/[monthly active users])]*(# of users of that channel on DEC/total # users across all DEC platform).

After site scoring, the site and score are added to a catalog (at 304) for rapid and easy access. Next, the scored and cataloged social network site (or other channel) is presented to the advertiser client for approval. This approval may proceed in alternative ways, depending upon embodiment.

In some embodiments, a social network desires to join the marketing platform's delivery system without requesting specific advertising content. In that scenario, the content management system performs a matching function that matches certain social networks with certain advertisers depending on matching criteria.

From the advertiser point of view, these additional social networks may appear as additional possible channels for their content, beyond the main channels of Facebook, YouTube, etc. The advertiser's approval of the new social network can occur, for example, when the advertiser selects that social network as a channel for advertising.

In some other embodiments, the social network is interested in particular content of the advertiser handled by the content management system. For example, the users of the social network might be talking about a particular movie for which the content management system has advertising content for.

In that case, the social network can request that particular content of that advertiser in the form of the first step above. That request is presented to the advertiser which then can accept or reject the request.

Once the advertiser (client) approves the display of content on the social network, the system may select which content is to be advertised on the site (at 310). In some cases, a particular advertisement may be pushed by the advertiser, or requested by the channel, in which case these desires may influence the content selection. Alternatively, in some cases a very limited set of advertisements may be available. In this case, the selection step may be trivial. However, in circumstances where a number of advertisements (or other content) are available for publishing on the channel, it may be desirable to perform improved sentiment driven content selection in order to improve the impact of the published content.

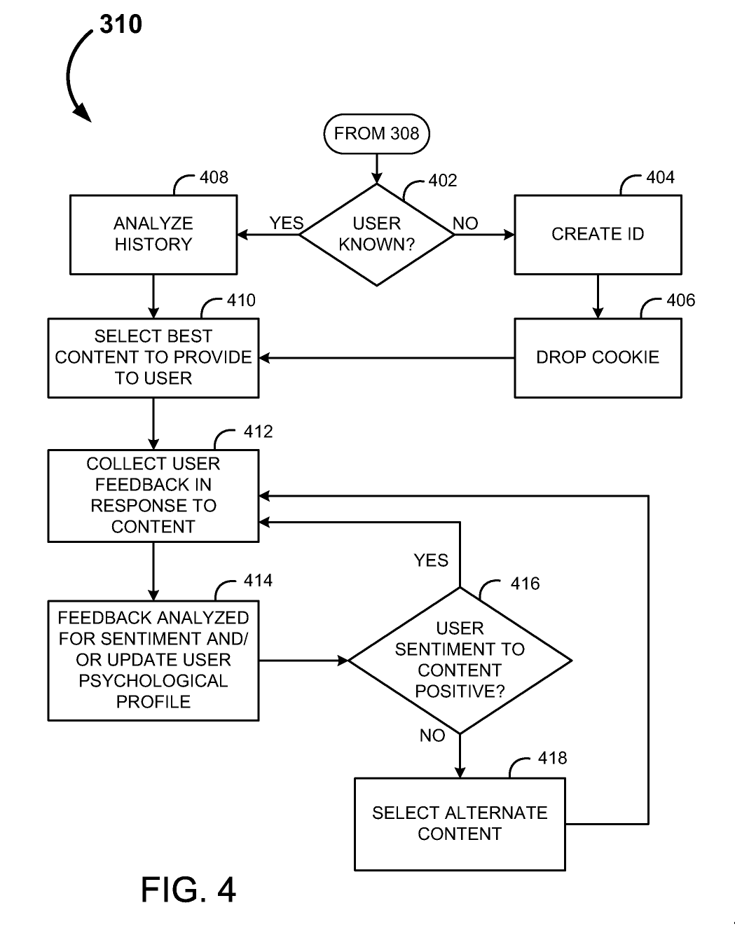

FIG. 4 provides an example process of generating tailored content for a user by based upon user sentiment (at 310). In this example process, initially a decision is made whether the user accessing the content provider is known (at 402). Users are “known” when they can be tied to a psychological profile. The content selection component of the content management system may identify tracking cookies upon the user's computer (or other computational device, such as tablets, mobile devices, etc.). If no identifying cookie exists, some embodiments of the automated reprogramming system may alternatively identify the user by device MAC address or other indication. In some embodiments, the user is known if she is logged into the social network (or other channel). For example, a user must supply a password and username to access their profile in Facebook or Twitter. The channel can use this authentication process in order to inform the content management system of the user's identity. By leveraging both login data and cookies, the content management system may be able to track users even when they are using different devices, and across different unrelated websites.

If the user is known, the user's history is analyzed (at 408). History analysis may include accessing the user's psychological profile from storage. Alternatively, if the user is not known, an ID may be generated for the user (at 404) which is associated with a new user psychological profile. The new psychological profile may be blank initially, or may include one of potentially several default profiles based upon “stereotypical” users that access the content provider, or otherwise based upon the user's activity. After the user ID is generated, the automated reprogramming system may drop a cookie (at 406) in order to facilitate tracking the user across various content providers (such as Twitter and Facebook, for example).

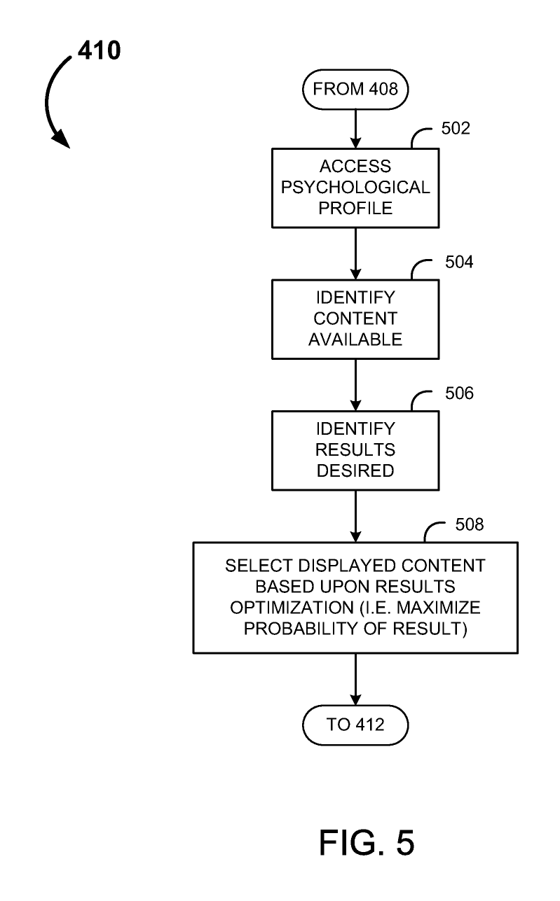

Once the psychological profile has been retrieved from storage (or newly generated), the system selects the best content to provide to the user (at 410). Turning to FIG. 5, an example flow chart for this sub process of content selection is illustrated. This process accesses the user's psychological profile (at 502). The psychological profile may include any number of variables that can be utilized to model user response to content. Typically, a psychological profile may include sentiments, interests, demographics, state of mind, habits, and networks, for example. Sentiments may indicate an overall personality such as “negative”, or “optimistic”. Interests may include topics the user is interested in, such as “movies”, “fashion” or “food”. Demographics may include information such as age, race, gender, and socioeconomics. State of mind may include overarching themes the user is involved in, such as “getting married”, “having a baby”, “buying a house” or other such life events that are persistently impacting the user. Habits may include behavioral habits such as being a “purchaser” or “sharer”. Network may include the user's friend lists and other contacts.

The system also queries the database for the content that is available for display to the user (at 504). The desired result is then determined by the system (at 506). The desired result, in the case of an advertisement, may include the user clicking upon the ad, or accessing the website that the advertisement is promoting. If the content is non-advertisement material, the desired result may include staying longer on the webpage, or exploring the content in greater detail. Other desirable results may include sharing of the content, making a purchase, broadcasting the content, or building up reputation of the content (typically through positive comments).

Once the system identifies which result is desired, it then models the probability of that result occurring for each of the available content based upon the user profile (at 508). This modeling may compare how other users with similar psychological profiles reacted to the content in order to build a probability function where each category in the psychological profile is a variable. The system may then optimize for the largest probability of the result occurring, given the available content. The identified content may be selected for display. In some embodiments, vector similarity may be employed to match the user profile to content. Content may be recommended via user-item collaborative filtering. Recommendations obtained from both content similarity and collaborative filtering may then be ranked using weights calculated from feedback and displayed to user, in some embodiments. Users may also be matched to one another using vector similarity, or comparable analytic techniques.

Returning to FIG. 4, once the content has been selected and displayed, the system collects feedback from the user (at 412) in response to the content. This feedback may include a comment, a desired result, or some other action by the user. The feedback may be analyzed for sentiment and the user's psychological profile may be updated (at 414).

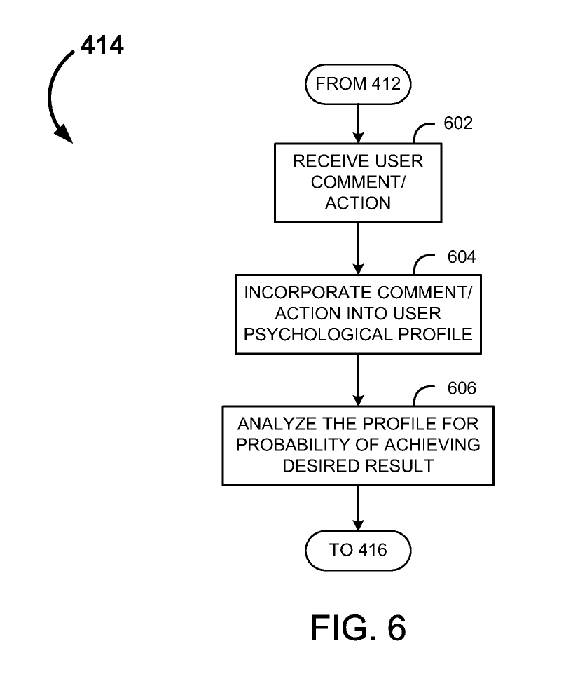

Turning now to FIG. 6, an example flow chart for the process of feedback analysis is illustrated. In this example process, the user's comment or action is received (at 602), and the comment or action is incorporated into the user psychological profile (at 604). For example, assume the user provides feedback to content including a comment of “Stop testing on animals”. The system may parse the comment, and perform syntactical analysis on the parsed comment. Based upon the analysis, the system may determine that changing the content is appropriate. It may also be possible that the comment may be analyzed for factual accuracy, and if inaccurate, content illustrating facts may be presented. For example, assume the brand being commented upon does not do animal testing. The system may then provide the user with a video illustrating how testing is performed in order to alter the negative opinion the user has of the brand. Similarly, if the comment was a question, such as “How do I do x?”, the system may provide videos or other content around that function. In a third example, the user states “I love this product.” In response, the system may provide content of the next version of the product. Conversely, if the user states “I hate this product”, the system may instead provide content of the product (or brand's) best feature. It is possible to analyze for Sentiment, Content and Context to build the profile and display appropriate content.

After the profile has been updated, it is again analyzed for the probability of achieving the desired result (at 606) in a manner similar to that discussed above. Returning to FIG. 4, the system determines if the user's sentiment is positive (at 416), and if so, maintains the content and awaits further user feedback. However, if the user reacts negatively to the content, then the system may select alternative content (at 418) using the updated psychological profile and probabilities.

In this manner, the system may build out a robust psychological profile for the user and leverage the profile to maximize the chance that content will have a desired result. If the system receives a negative feedback from the user, the profile is updated, and the content reviewed for alternatives. This ensures the user is consistently provided relevant and desirable content.

Further, by utilizing a cookie tied to the user's ID, the system is able to track the user across different content providers' platforms. Thus, comments on a Facebook page may bolster the user's psychological profile and alter the content the user may experience on an entirely different portal, such as YouTube.

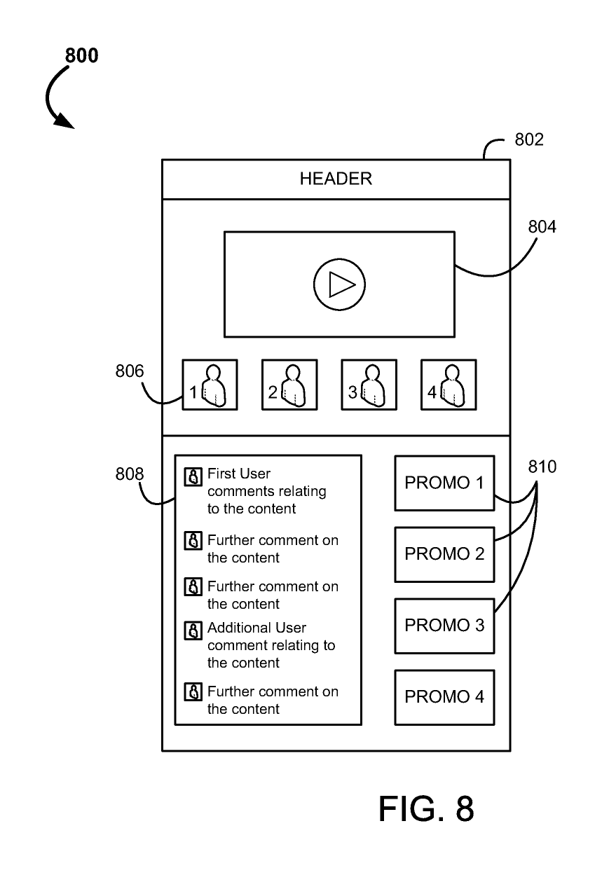

FIG. 8 is an example screenshot 800 of a channel webpage in which the automated channel addition system may be employed, in accordance with some embodiments. In this example screenshot, a header 802 is displayed, below which a primary content 804 is presented. Alternate content 810 is highlighted in a sidebar in this example. This example screen also includes a comments section 806. The users are displayed in thumbnails 808. The system logs the users' activity on the page. In some embodiments, a table of activities may be generated in the following format:

| | | Content | | | | | |
|---|---|---|---|---|---|---|---|
| User | Date/ | Descrip- | User | | Facebook | | Twitter |
| ID | Time | tion | Action | Object | ID | . . . | ID |
| 1 | September | Brand 1 | Media | 2 | Stacy2012 | . . . | |
| | 2013 | | | | | | |
| | 11:00 | | View | | | | |
| 1 | September | Brand 1 | Com- | Stop | | . . . | SMiller8 |
| | 2014 | | ment | | | | |
| | 12:32 | | | testing | | | |
| | | | | on | | | |
| | | | | animals | | | |
| 1 | September | Brand 2 | Show | 4 | Stacy2012 | . . . | |
| | 2014 | | times | | | | |
| | 2:43 | | | | | | |
| 2 | August | Brand 1 | Media | 2 | MerryMan | . . . | |
| | 1929 | | View | | | | |
| | 9:02 | | | | | | |

As can be seen in the example table, each user is given a user ID (persistent identification) that is independent from other content provider IDs. While the table is illustrated as including Facebook and Twitter, typical data sets will include a very large number of channels, where the user's ID can be associated with an ID native to each channel.

Using this example table's dataset, a user ID number 1 was recorded viewing a Brand 1 media clip on September 13^{th} on her Facebook account. The same user then posted a comment on Twitter on September 14 stating “Stop testing on animals.” Sentiment analysis on the comment determines that this user has reacted badly to the content displayed on Facebook, and alternate content may be selected for display to the user. This sentiment analysis may be performed upon subsequent page loading, or may be performed instantly once a negative sentiment is received. In this way, it may be possible to replace offending content as rapidly as possible in order to protect the advertisers, and also to maintain user satisfaction. Below the process for reprogramming content on the social networks 104a to 104n, and other content providers, will be described in greater detail.

Returning to FIG. 3, after the content has been selected, the system may publish the selected content to the channel (at 312). This publishing step utilizes the form data provided by the social network, or other channel, to tailor the content to that channels API.

Optionally, a further step may be performed (not illustrated) in which the system determines payment to the channel for prompting its users to engage with the marketing platform. Currently, when advertisers manually connect to social networks, the advertisers do not pay the social network for access to the social networks users. However, since the social network (or other channel) needs to initially request connection and provide their site for appraisal, a cost per engagement model may be employed to incentivize active participation by social networks.

This system and process for automated channel addition may be the first, ideal application for cost per engagement remuneration. Ultimately, what this system delivers to the advertisers is the engagement of social network users. A cost per engagement pricing model ensures that there is payment to the social network only if there is actual, measured engagement. Thus, with automated channel addition, advertiser motivation matches precisely what the social network actually delivers.

Another reason why automated channel addition may be the ideal application for cost per engagement is that via automated channel addition, the content management system is the entity that directly captures and records the engagement activity of social media users, including comments, “likes”, “sharing” etc. Since the content management system is a third party between the advertiser and the channel, there is no incentive for the content management system to inflate or deflate the recorded engagement metrics.

As an alternative to or in parallel with cost per engagement compensation, the content management system could provide a gamification experience for these smaller channels that connect with the platform in the way disclosed herein. In this gamified experience, these social networks would compete for badges, rankings on leaderboards and such in order to get favored placement by the platform in front of the advertisers.

### III. CAMPAIGN MANAGER

Now that the addition of channels has been described, attention will be turned toward the systems and processes of closed loop confirmation of user generated content. As previously noted, closed loop confirmation mitigates much of the copyright and privacy risks associated with using user generated content.

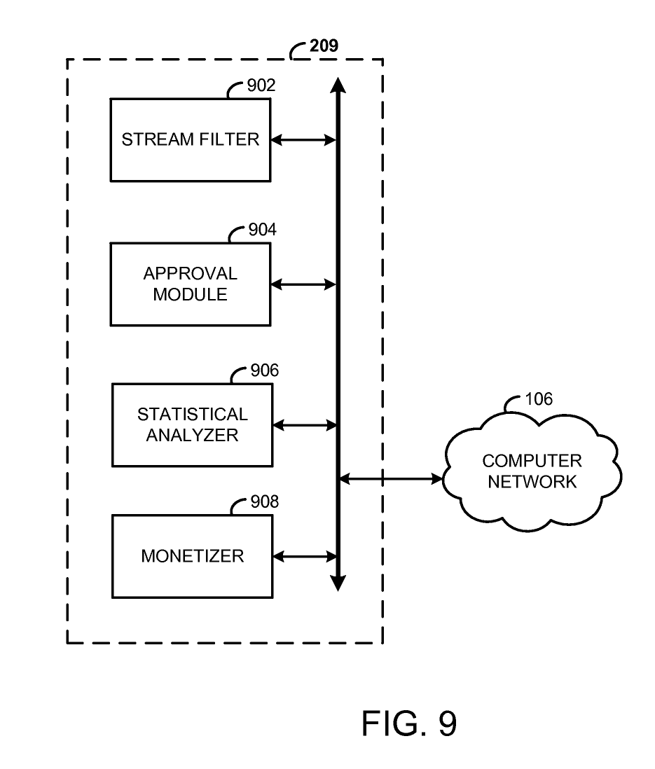

FIG. 9 is an example block diagram for the campaign manager 209, in accordance with some embodiments. The campaign manager includes a stream filter 902, an approval module 904, a statistical analyzer 906 and a monetizer 908. The stream filter 902 receives a stream of content from social networks, and filters the content for keywords, or other brand identifiers in order to select content of interest. For example, the manufacturer of Pepsi may desire that social media streams are filtered for content that includes the term “Pepsi” along with positive associating language. Likewise, they may be interested in content that includes the term “Coke” and disparaging language. The keywords, images and/or terms that are filtered for may be configurable by each brand owner/advertiser.

Once content of interest has been filtered for, the approval manager 904 may reach out to the user who generated the content, and seek approval for its usage by the brand owner and/or advertisers. This approval process is known as closed loop confirmation, and may be performed within the content platform, or may include a redirect to an external webpage for approval.

In many cases approvals can be gained without providing the user any additional compensation. In other embodiments, users may be supplied with loyalty points, marginal cash incentives, coupons for the product the content is regarding, or entry into a lottery (or any other incentive program). This ensures that users are willing to provide approvals more readily, especially when the approval process is first deployed.

Approval may be for a single content article, or may be extended to groupings of content that the user has generated. In some cases, the user may be asked for a blanket approval for content that they generate within time constraints, media constraints (e.g., all comments by the user, but not images), etc.

After approval is gained for the desired content, it may be provided to the brand owners and/or advertisers via the monitizer 908. The statistical analyzer 906 can generate analytics on which users generate the most content, the rate of user approval to monetize the content, and quality of the content (as measured by the usage of the content by the brand owners/advertisers, and/or the perceived impact in the marketplace).

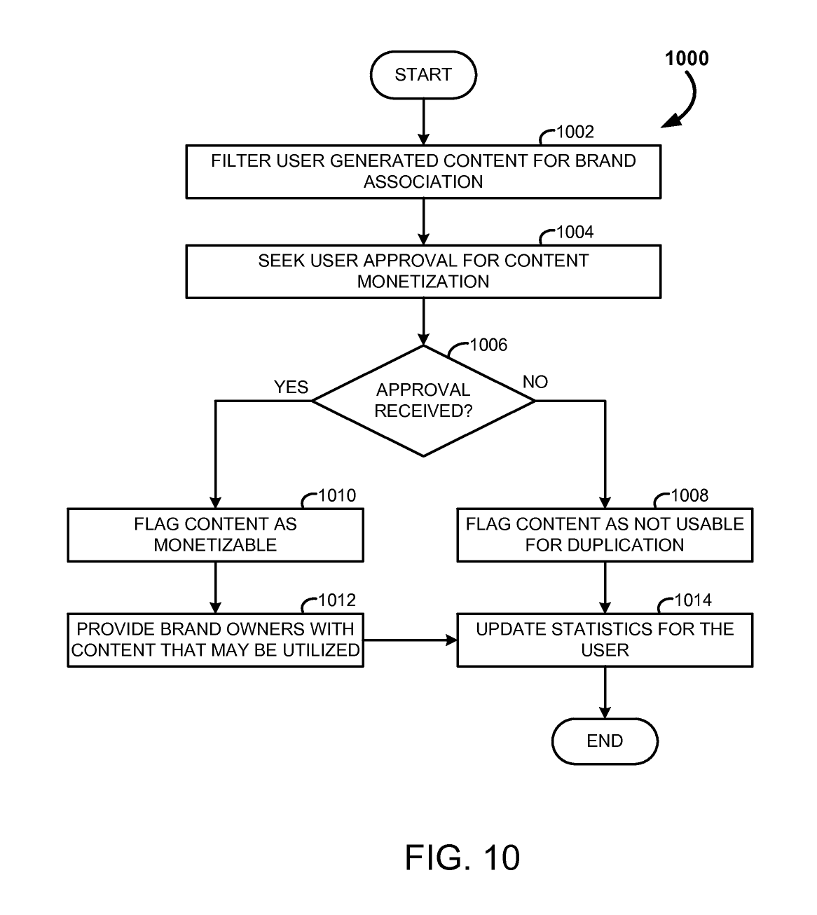

Now that the system for the campaign manager 209 has been adequately discussed, attention will be turned to the process of closed loop confirmation. FIG. 10 is an example flow chart for closed loop confirmation of approval to use the user generated content, shown generally at 1000. This process starts with the filtering of user generated content for brand association (at 1002).

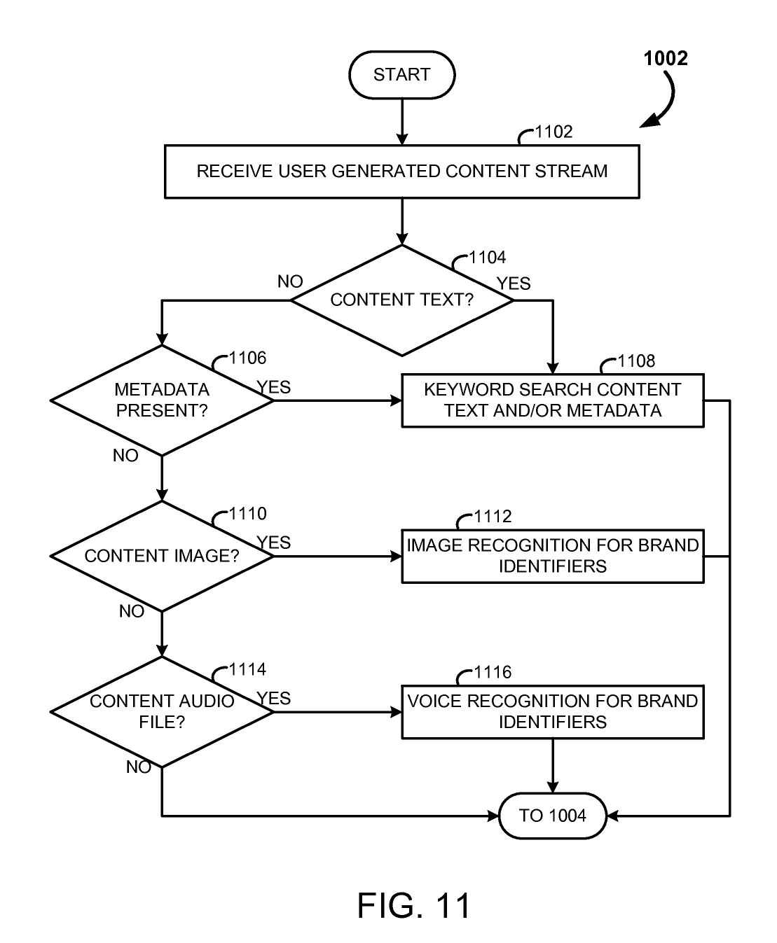

FIG. 11 provides a more detailed view of this sub-process of content filtration. First the stream of content is received from the social networks (at 1102). The content is then reviewed to determine if it is textual in nature (at 1104). If it is not textual, then the process still inquires if the content has embedded metadata (at 1106). Metadata typically includes textual data such as tags in an image. If metadata is present, or if the content is textual in nature, then the content may undergo a keyword search (at 1108). This keyword search may be a simple search for brand names, or may include contextual searches (such as including sentiment associations with the brands).

If however the content is not textual, or including metadata, then the process determines if the content includes images (at 1110). If the content includes images, the image recognition software may be employed (at 1112) to identify brands of interest, or other identifiers. Additionally, the image recognition may include facial recognition algorithms, which may be enabled to identify the number of people in the image, and their identity (based upon the social network profile data). In this way, all individuals in an image may be asked for approval before the image is used in order to avoid misappropriation of likeness claims.

If the content is not an image, however, the system may inquire if the content is an audio file (at 1114). If so, then audio recognition may be utilized to identify if keywords are included in the audio (at 1116). Although not illustrated, other content types may be similarly filtered to identify content of interest. For example, a video file may have the metadata queried, as well as image and audio recognition applied in order to determine if the content is of interest. Likewise, executable files may be filtered in similar ways.

In addition to these automated filtering mechanisms, content may also be identified by advertiser searches, or other manual operation. For example, if content is trending on YouTube, an advertiser may wish to use the content in relation to their product, even if it doesn't have any relation to the product. Appeal by association is very common within advertising, and may be employed within filters as well. For example, content with a particular popularity threshold may be filtered for even if no other keywords match the content.

Additionally, filters may extend to beyond keywords and contextual searches. For example content can also be filtered by media type, user it is generated by, media host, by hashtag, by DEC submission or other flags.

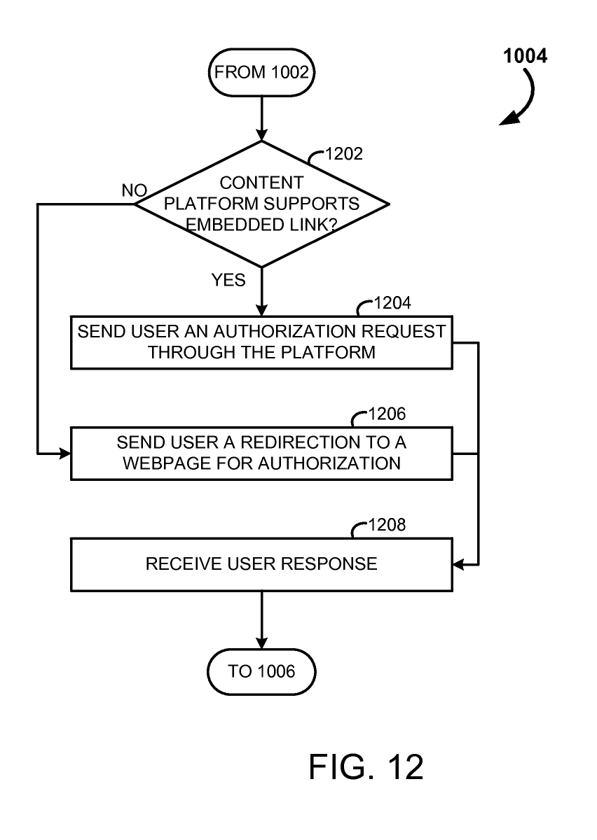

Returning to FIG. 10, after filtering of content is complete, the process progresses to where user approval is sought for the usage of the content by brand owners and/or advertisers (at 1004). FIG. 12 provides a more detailed example flow chart for seeking user approval.

This process starts by querying whether the content platform supports embedded links (at 1202). If so, the user can be sent an authorization request within the native platform (at 1204). Otherwise, the user may be redirected to a webpage for authorization of the content (at 1206). Regardless of whether the authorization is done within the content platform or not, the response is received by the system (at 1208).

Note that, in some embodiments, approval for the use of content may only be sought once the advertiser expresses interest in using the content. Thus, advertisers, in these embodiments, are provided all content that matches their filter requirements, and they select which content is of interest. Approval requests are then sent for these particular content articles. Such mechanisms reduce the number of approval requests which are sent, thereby reducing “fatigue” by users. If users are constantly bombarded by approval requests, they tend to rapidly lose interest in responding to them. In contrast, if they are only selected occasionally for approval, they are far more likely to respond positively to the approval request.

Returning to FIG. 10, after the response is received, the process may determine if the response consisted of an approval to use the content, or a denial (at 1006). If the content is denied, then the system flags the content as not for duplication by advertisers and/or brand owners (at 1008).

If, on the other hand, the user approves the content, then it is flagged as being eligible for monetization (at 1010). This content is then presented to the brand owners and/or advertisers for utilization in their marketing campaigns (at 1012). Regardless of the approval or denial of the content, the statistics for the user are updated (at 1014) including how often the user's content is filtered for use, their approval rates, and how often the content is subsequently monetized. These statistics enable the system to streamline performance, as users who routinely deny usage of their content may be excluded from subsequent filters, and users who generate a lot of monetizable content may be included more readily in the filters.

### IV. EXAMPLES

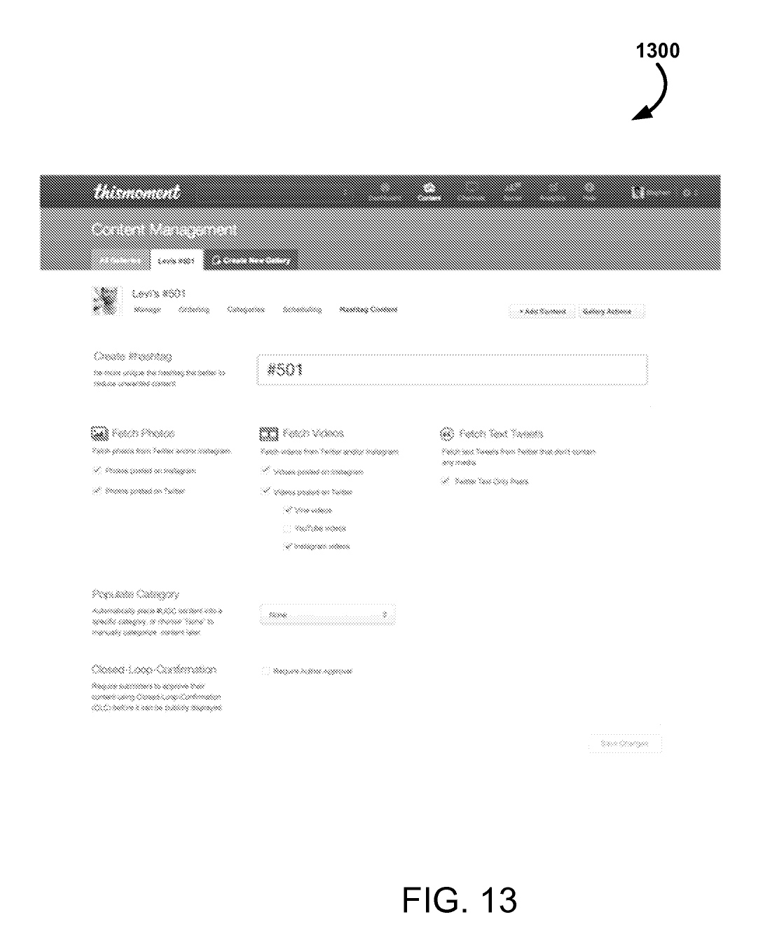

Now that the process for closed loop confirmation has been discussed, attention will be turned to a series of example screenshots in order to better illustrate the system's operation. FIG. 13 is an example screenshot for a campaign manager, shown at 1300. In this example screenshot, the advertiser is able to input a hashtag associated with the product. The advertiser is then able to seek content from any number of social media sites. The advertiser has the option to select that only content that has been approved by the user is displayed (shown as a checkbox next to closed loop confirmation).

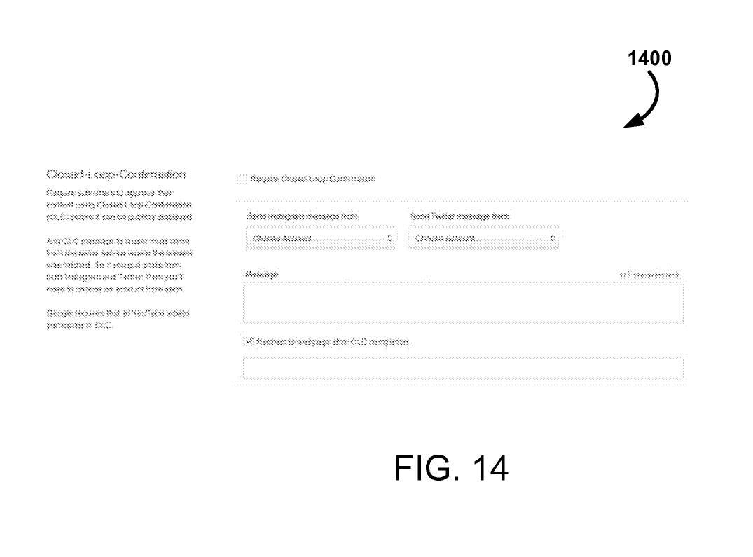

FIG. 14 is an example screenshot for a closed loop confirmation request, shown generally at 1400. This request may be sent within the social media platform from the advertiser to the user. The request may include an embedded approval link, or may include a redirection to an external website where approval can be performed.

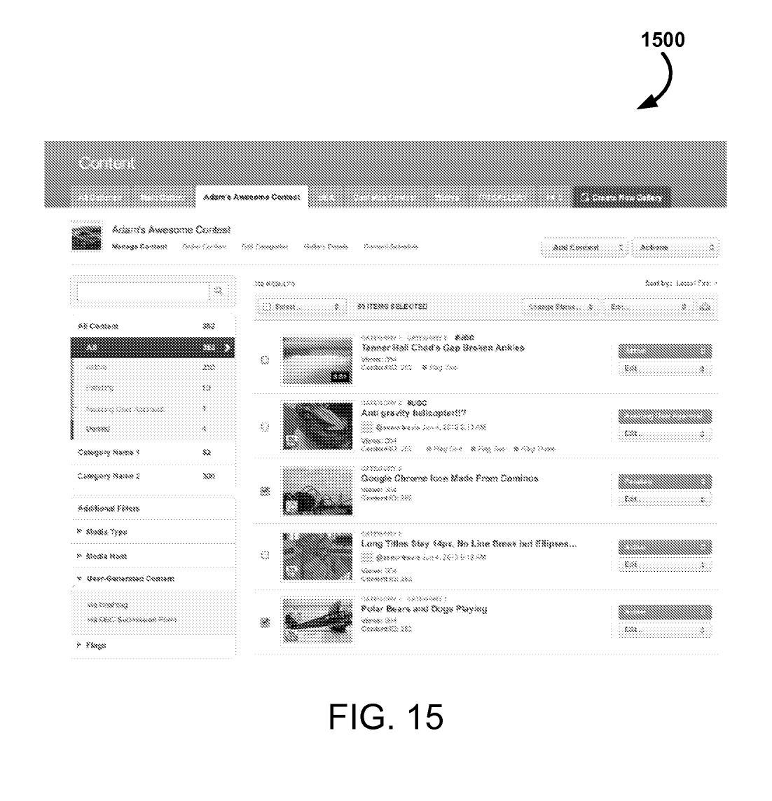

FIG. 15 is an example screenshot for a content gallery, shown generally at 1500. In this example screenshot, content is displayed along with its approval status. For example, the content may be waiting for approval, be active, be pending, or be denied. Pending is the term utilized for content which has already been selected for, but has not yet been sent an approval request.

In addition to the content being displayed, a summary of content status and category may also be presented. Filters may be set on this page as well.

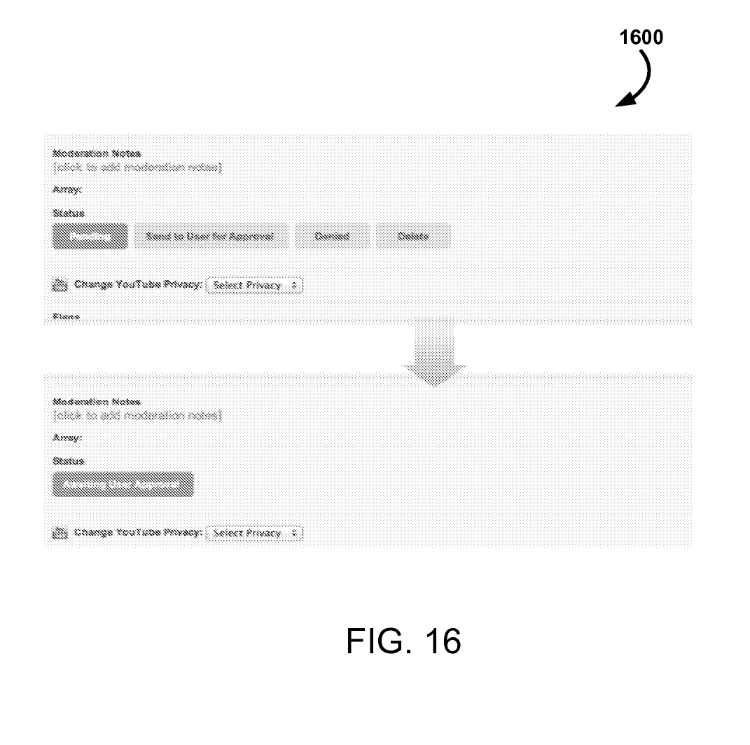

FIG. 16 is an example screenshot for an approval status field, shown generally at 1600. Thus, for a given article of content it is pending until the advertiser selects whether to ask the user for approval, it's denied, or deleted. If the advertiser wishes to use the content, the approval request is sent, and the status is updated to awaiting approval.

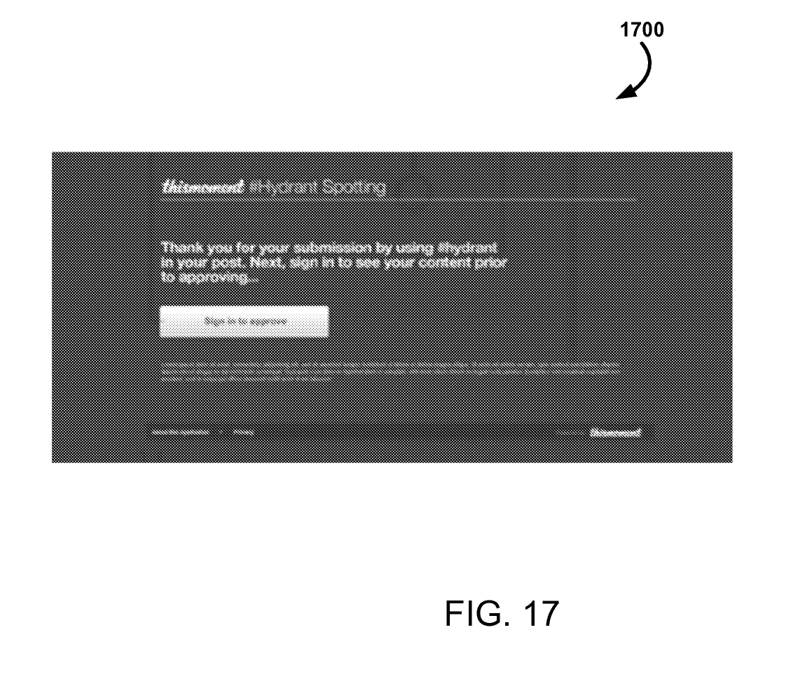

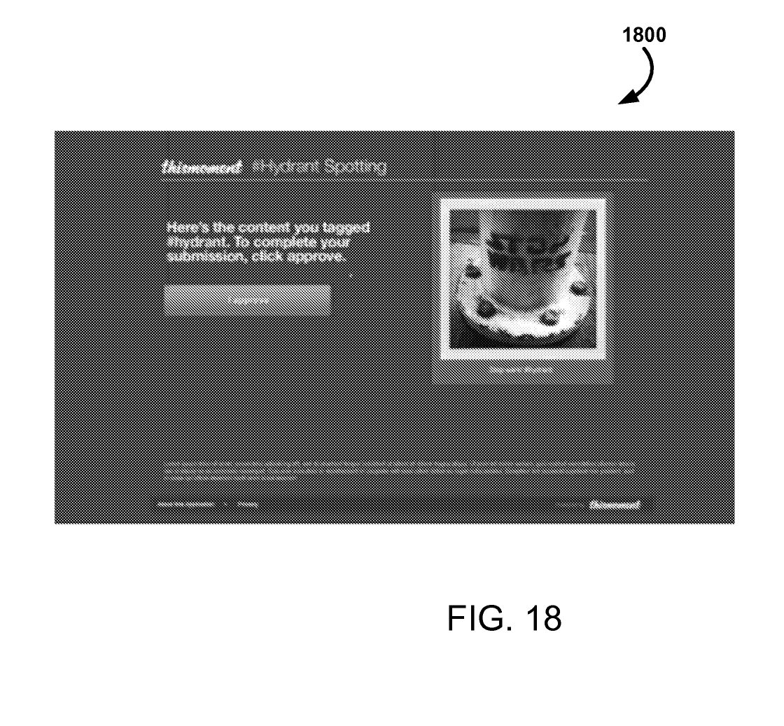

FIG. 17 is an example webpage screenshot of when an approval request is sent to the user, shown generally at 1700. The screen indicates that the content is being considered for usage, and has a means for the user to sign into the system to approve the content. Once the user signs in, they are presented with an approval webpage, as seen in relation to FIG. 18 at 1800. In the approval page, the content being approved is presented to the user, and the user is prompted to select the content for approval.

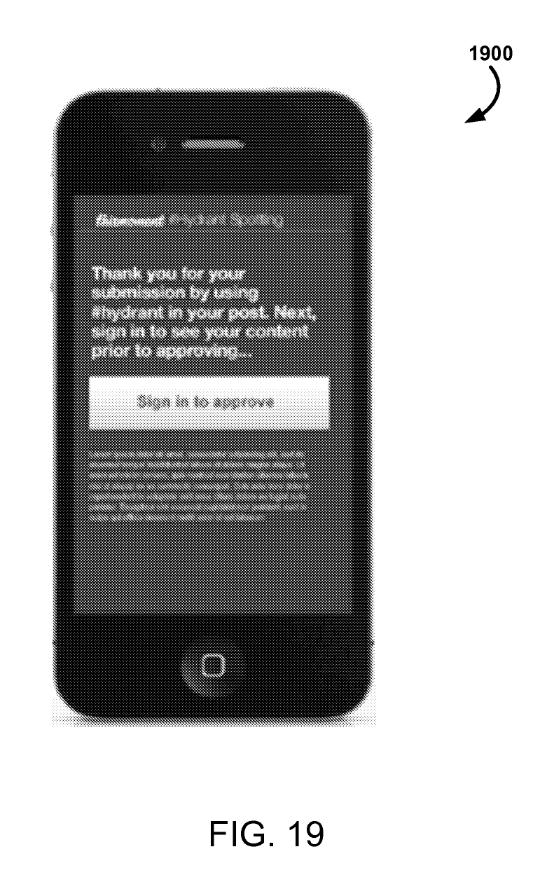

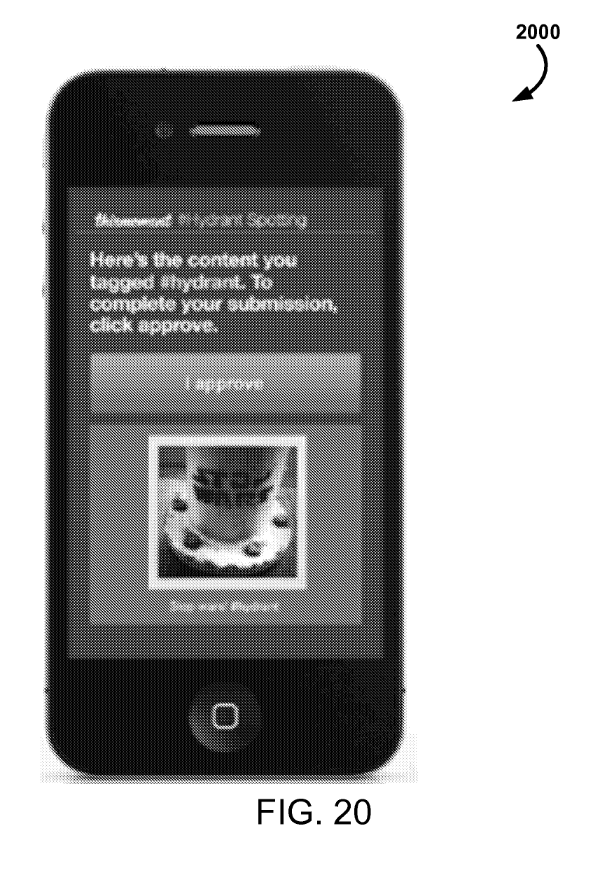

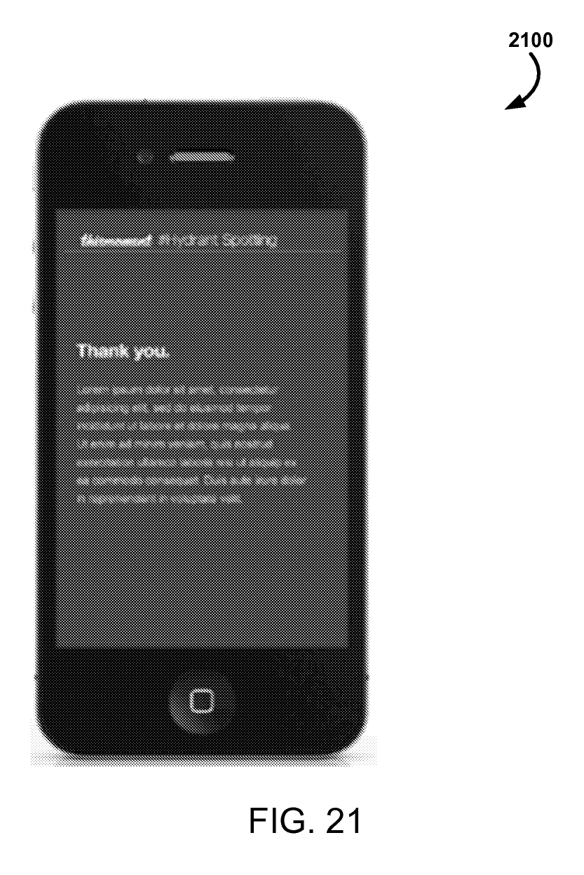

A similar interface may be employed for mobile devices, where increasingly social networking is taking place. FIG. 19, for example, illustrates the same login page, shown at 1900, on a mobile device. Again, once the user signs in, the device may now display the content and an approval selection, as seen at 2000 in relation to FIG. 20. Once the content has been approved, the device displays an appreciation landing page, as seen at 2100 in relation to FIG. 21. As previously discussed, in embodiments where approval is associated with some sort of reward, this appreciation landing page may include the reward summary. For example, the page may illustrate a number of loyalty points the user has collected, or may include a scan-able coupon for the product.

### V. SYSTEM EMBODIMENTS

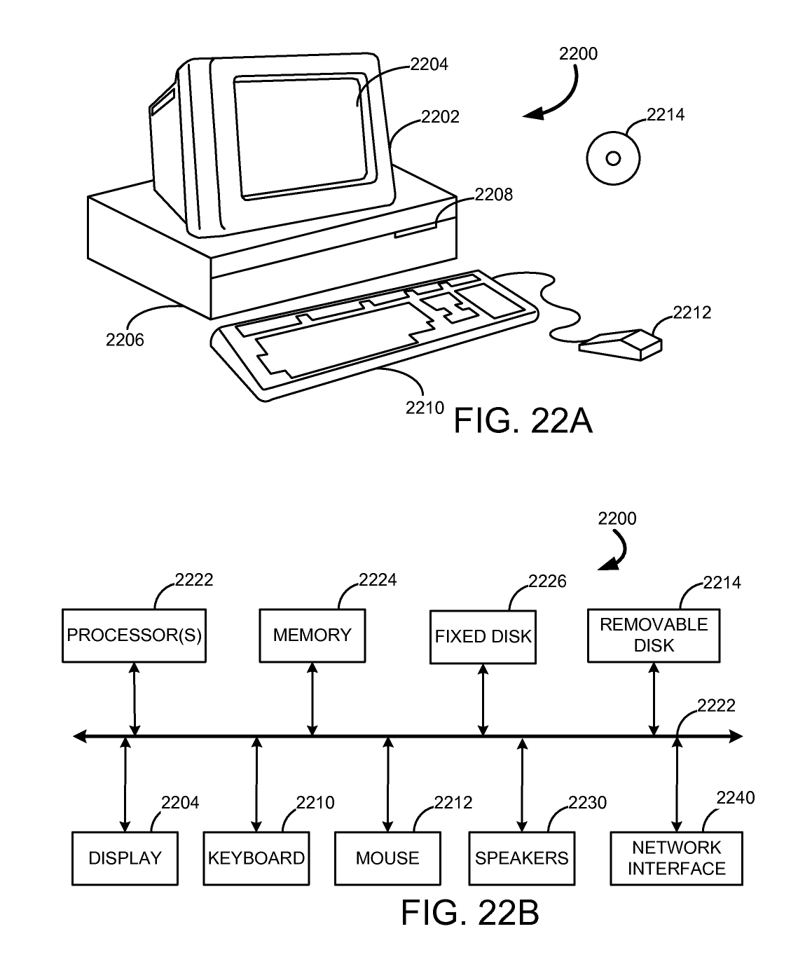

FIGS. 22A and 22B illustrate a Computer System 2200, which is suitable for implementing embodiments of the present invention. FIG. 22A shows one possible physical form of the Computer System 2200. Of course, the Computer System 2200 may have many physical forms ranging from a printed circuit board, an integrated circuit, and a small handheld device up to a huge super computer. Computer system 2200 may include a Monitor 2202, a Display 2204, a Housing 2206, a Disk Drive 2208, a Keyboard 2210, and a Mouse 2212. Disk 2214 is a computer-readable medium used to transfer data to and from Computer System 2200.

FIG. 22B is an example of a block diagram for Computer System 2200. Attached to System Bus 2220 are a wide variety of subsystems. Processor(s) 2222 (also referred to as central processing units, or CPUs) are coupled to storage devices, including Memory 2224. Memory 2224 includes random access memory (RAM) and read-only memory (ROM). As is well known in the art, ROM acts to transfer data and instructions uni-directionally to the CPU and RAM is used typically to transfer data and instructions in a bi-directional manner. Both of these types of memories may include any suitable of the computer-readable media described below. A Fixed Disk 2226 may also be coupled bi-directionally to the Processor 2222; it provides additional data storage capacity and may also include any of the computer-readable media described below. Fixed Disk 2226 may be used to store programs, data, and the like and is typically a secondary storage medium (such as a hard disk) that is slower than primary storage. It will be appreciated that the information retained within Fixed Disk 2226 may, in appropriate cases, be incorporated in standard fashion as virtual memory in Memory 2224. Removable Disk 2214 may take the form of any of the computer-readable media described below.

Processor 2222 is also coupled to a variety of input/output devices, such as Display 2204, Keyboard 2210, Mouse 2212 and Speakers 2230. In general, an input/output device may be any of: video displays, track balls, mice, keyboards, microphones, touch-sensitive displays, transducer card readers, magnetic or paper tape readers, tablets, styluses, voice or handwriting recognizers, biometrics readers, motion sensors, brain wave readers, or other computers. Processor 2222 optionally may be coupled to another computer or telecommunications network using Network Interface 2240. With such a Network Interface 2240, it is contemplated that the Processor 2222 might receive information from the network, or might output information to the network in the course of performing the above-described closed loop confirmation. Furthermore, method embodiments of the present invention may execute solely upon Processor 2222 or may execute over a network such as the Internet in conjunction with a remote CPU that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher level code that are executed by a computer using an interpreter.

In sum, the present invention provides systems and methods for closed loop confirmation. Such systems and methods enable advertisers to access a much wider variety of user generated content, without significant legal exposure.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A computerized method for seeking confirmation from users, useful in conjunction with platforms capable of hosting user generated content, the method comprising:
filtering, using a processor, user generated content from at least one platform to identify content of interest;
collecting confirmation from the user to use the content of interest, wherein the user is directed to a separate application from the platform for collection of confirmation;
categorizing confirmed content as usable;
providing the confirmed content to a content promoter;
generating statistics about the user generated content.

2. The method of claim 1, wherein the providing the confirmed content includes collecting the confirmed content into a content management system accessible by the content promoter, wherein the content promoter is at least one of brand owners, advertisers, research organizations, system administrators, corporations, and nonprofit organizations.

3. The method of claim 1, wherein the filtering includes searching for at least one keyword, and wherein the filtering includes contextual analysis of the at least one keyword.

4. The method of claim 1, wherein the filtering includes image recognition for at least one of a product, logo, brand identifier, and facial recognition.

5. The method of claim 4, wherein the confirmation is collected from all individuals identified by the facial recognition.

6. The method of claim 1, wherein the filtering includes at least one of audio recognition and geolocation.

7. The method of claim 1, wherein the confirmation includes authenticating the user.

8. The method of claim 1, wherein the confirmation includes receiving at least one qualifying attribute in addition to consent for usage from the user, wherein the at least one qualifying attribute includes at least one of age, affiliation, geography, demographic, preference, gender, and existing customer loyalty program.

9. The method of claim 12, further comprising soliciting users, based upon the at least one qualifying attribute, for another platform.

10. The method of claim 1, wherein the statistics include at least one of quantities of content of interest they generate, and approval ratios.

11. The method of claim 14, wherein the filtering is weighted by the user statistics.

12. A system for seeking confirmation from users, useful in conjunction with platforms capable of hosting user generated content, the system comprising:
a crawler, including a processor, configured to filter user generated content from at least one platform to identify content of interest;
a confirmation module configured to collect confirmation from the user to use the content of interest, wherein the user is directed to a separate application from the platform for collection of confirmation, and categorizing confirmed content as usable;
an interface configured to provide the confirmed content to a content promoter;
an analyzer configured to generate statistics about the user generated content.

13. The system of claim 12, wherein the interface is a content management system accessible by the content promoter, and wherein the content promoter is at least one of brand owners, advertisers, research organizations, system administrators, corporations, and nonprofit organizations.

14. The system of claim 12, wherein the crawler searches for at least one keyword, and wherein the crawler performs contextual analysis of the at least one keyword.

15. The system of claim 12, wherein the crawler performs image recognition for at least one of a product, logo, brand identifier, and facial recognition.

16. The system of claim 15, wherein the confirmation is collected from all individuals identified by the facial recognition.

17. The system of claim 12, wherein the crawler performs at least one of audio recognition and geolocation.

18. The system of claim 12, wherein the confirmation module authenticates the user.

19. The system of claim 12, wherein the confirmation module receives at least one qualifying attribute in addition to consent for usage from the user, wherein the at least one qualifying attribute includes at least one of age, affiliation, geography, demographic, preference, gender, and existing customer loyalty program.

20. The system of claim 19, further comprising a solicitation module configured to solicit users, based upon the at least one qualifying attribute, for another platform.

21. The system of claim 12, wherein the statistics include at least one of quantities of content of interest they generate, and approval ratios.

22. The system of claim 21, wherein the crawler's filtering is weighted by the user statistics.

23. A computerized method for communicating with users, useful in conjunction with social media networks, the method comprising:
filtering, using a processor, user profiles for target users; and
collecting at least one qualifying attribute from the target users, wherein the user is directed to a separate application from the social media networks for collection of the at least one qualifying attribute.

24. The method of claim 23, wherein the at least one qualifying attribute includes at least one of age, affiliation, geography, demographic, preference, gender, and existing customer loyalty program.

25. The method of claim 23, further comprising soliciting users, based upon the at least one qualifying attribute, for a platform separate from the social media networks.

26. The method of claim 23, wherein the user profiles are user accounts on the social media networks, and wherein each user account is generated by a user.

27. The method of claim 23, further comprising providing the at least one qualifying attribute to a third party.
